(19) United States
(12) Patent Application Publication
(10) Pub. No.: US 2006/0007503 A1
(43) Pub. Date: Jan. 12, 2006

(54) Image editing apparatus, and image editing method and program

(75) Inventor: Hiroaki Nakamura, Ashigara-Kami-Gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/177,605

(22) Filed: Jul. 11, 2005

(30) Foreign Application Priority Data
Jul. 9, 2004 (JP) 2004-203065

(51) Int. Cl. H04N 1/387

(52) U.S. Cl. 358/452

(57) ABSTRACT

The image editing apparatus comprises: an image input device to which an image photographed by a predetermined photographic device is inputted; a date presence determination device which determines whether or not a date which has been entered by the photographic device is present in the image having been inputted to the image input device; a date insertion device which has a capacity of inserting a date into the image having been inputted to the image input device; an image output device which outputs the image inputted to the image input device; and a control device which determines whether or not to control the date insertion device to insert the date according to a result determined by the date presence determination device, wherein if the control device determines to control the date insertion device to insert the date, the control device controls the image output device to output the image in which the date has been inserted by the date insertion device.

### BACKGROUND OF THE INVENTION

1. Field of the Invention

The present invention relates to an image editing apparatus, an image editing method and a program, and more particularly to an image editing apparatus, an image editing method and a program that can insert a date into an image in which a subject is photographed.

2. Description of the Related Art

Conventionally, techniques are known in which the photography date is inserted into the photographed image at the time of printing and a photo print is created when a photographed image to be printed is received from a customer (see Japanese Patent Application Publication No. 2003-224793 and Japanese Patent Application Publication No. 2002-10066). For example, the year, month, and day of photography are inserted into a corner of the photographed image and the photo print is created.

On the other hand, a variety of photographic devices are provided in which the photography date is written into the photographed image in advance at the time of photographing.

However, if the date is already inserted into a photographed image by the photographic device at the time of photographing the subject, the date may be inserted in duplicate by inserting the date into the photographed image by the printer at the time of printing. In the case in which the date is inserted in duplicate, if the dates are inserted at displaced positions at the time of photographing and the time of printing, a photographic print may be created that has a poor appearance, or a photographic print may be created in which the date is unrecognizable.

In order to avoid such a duplicate insertion of the date, generally, while displaying on a monitor one by one each image which is to be printed, the operator must perform an operation to reject the function which inserts the date to the photographed image if the date has already been inserted to the image.

### SUMMARY OF THE INVENTION

The present invention is contrived in view of such circumstances, and an object thereof is to provide an image editing apparatus, an image editing method and a program that can output an image avoiding duplicate insertion of the date without requiring an extra operation.

In order to attain the aforementioned object, the present invention is directed to an image editing apparatus comprising: an image input device to which an image photographed by a predetermined photographic device is inputted; a date presence determination device which determines whether or not a date which has been entered by the photographic device is present in the image having been inputted to the image input device; a date insertion device which has a capacity of inserting a date into the image having been inputted to the image input device; an image output device which outputs the image inputted to the image input device; and a control device which determines whether or not to control the date insertion device to insert the date according to a result determined by the date presence determination device, wherein if the control device determines to control the date insertion device to insert the date, the control device controls the image output device to output the image in which the date has been inserted by the date insertion device.

In order to clearly differentiate the subject of inserting the date in the claims, it should be noted that the term “enter” is used for inserting the date carried out by the photographic device, and that the term “insert” is used as it is for inserting the date carried out by the image editing apparatus according to the present invention.

Furthermore, there are various modes of inserting the date. For example, sometimes the insertion order may be year, month, day, and sometimes it may be day, month, year, but the insertion is not limited to those orders in particular. The hour and minute may be inserted along with the year, month, and day. Sometimes, the hour, minute and second may be inserted along with the year, month, and day. It is also possible that only the month and day are inserted. In addition, it is also possible that the day of the week is inserted.

Herein, the “date” that is inserted is specifically an image that indicates the date (i.e. a date image). The insertion of the date image is carried out, for example, by superimposing the date image on a portion of an image that is obtained by photographing a subject with a photographic device (photographed image). The present invention is not particularly limited to the case in which a date image is inserted by superimposing.

By this configuration, it is possible to determine whether or not a date is present that has been entered by the photographic device into the image photographed by the photographic device, and to control the image output device to output an image in which the date has been inserted by the date insertion device according to the result of the determination. Therefore, it is possible to output an image, and to avoid duplicate insertion of the date without an extra operation at the time of image output.

The present invention is also directed to the image editing apparatus wherein if the date presence determination device determines that the date which has been entered by the photographic device is present in the image having been inputted to the image input device, the control device controls the date insertion device to insert the date into the image having been inputted to the image input device.

The present invention is also directed to the image editing apparatus further comprising: a date erasure device capable of erasing a date from the image having been inputted to the image input device, wherein if the date presence determination device determines that the date which has been entered by the photographic device is present in the image having been inputted to the image input device, the control device controls the date erasure device to erase the date which has been entered by the photographic device from the image having been inputted to the image input device, and controls the date insertion device to insert the date into the image that the date which has been entered by the photographic device is erased by the date erasure device.

The present invention is also directed to the image editing apparatus wherein if the date presence determination device determines that no date which has been entered by the photographic device is present in the image having been inputted to the image input device, the control device controls the date insertion device to insert the date into the image having been inputted to the image input device.

The present invention is also directed to the image editing apparatus further comprising: an order information obtaining device which obtains order information indicating whether or not there is an order for inserting the date, wherein if there is no order for inserting the date according to the order information, the control device controls the date insertion device not to insert the date into the image having been inputted to the image input device.

The present invention is also directed to the image editing apparatus further comprising an order information obtaining device which obtains order information indicating whether or not there is an order for inserting the date, wherein if there is no order for inserting the date according to the order information, the control device controls the date insertion device not to insert the date into the image having been inputted to the image input device; and controls the date erasure device to erase the date which has been entered by the photographic device.

The present invention is also directed to the image editing apparatus wherein if the date presence determination device determines that the date which has been entered by the photographic device is present in the image having been inputted to the image input device, the control device controls the image output device to output the image without inserting the date by the date insertion device; and if the date presence determination device determines that no date which has been entered by the photographic device is present in the image having been inputted to the image input device, the control device controls the image output device to output the image that the date has been inserting by the date insertion device in the image having been inputted to the image input device.

The present invention is also directed to the image editing apparatus wherein: if the date presence determination device determines that the date which has been entered by the photographic device is present in the image having been inputted to the image input device, the control device determines a visibility of the date according to a difference in color between the date which is entered by the photographic device and a peripheral area thereof; and if the control device determines that the visibility of the date which has been entered by the photographic device is lower than a prescribed threshold value, the control device controls the date insertion device to insert the date into the image having been inputted to the image input device.

The present invention is also directed to the image editing apparatus further comprising: a date information obtaining device which obtains at least one of date information in a header appended to the image, and date information in a photography information file associated with an image file containing the image, wherein the date insertion device inserts the date according to the date information which is obtained by the date information obtaining device.

The present invention is also directed to the image editing apparatus further comprising: a storage device which stores table information including information related to the date which has been entered by the photographic device in accordance with a model of the photographic device, and a model information obtaining device which obtains at least one of model information in a header appended to the image, and model information in a photography information file associated with an image file containing the image, wherein the date presence determination device determines whether or not the date which has been entered by the photographic device is present according to the model information which is obtained by the model information obtaining device, and the table information.

Preferably, the table information includes at least one of a position, a color, and a character shape of the date which are entered by the photographic device.

The present invention is also directed to the image editing apparatus wherein the image output device carries out at least one of a process which outputs the image to a predetermined printer, and a process which records the image on a predetermined recording medium.

The present invention is also directed to the image editing apparatus further comprising: an output target range extraction device which extracts an image of an output target range from the image having been inputted to the image input device, wherein: the date presence determination device determines whether or not the date which has been entered by the photographic device is present in the image of the output target range; and the date insertion device inserts the date into the image of the output target range according to a result determined by the date presence determination device.

The present invention is also directed to the image editing apparatus further comprising: a portrait/landscape photography determination device which determines whether the image having been inputted to the image input device is a portrait orientation image or a landscape orientation image, wherein the date insertion device conforms a vertical orientation of the date to be inserted in the image to the vertical orientation of the image, according to a result determined by the portrait/landscape photography determination device.

The present invention is also directed to the image editing apparatus further comprising a date correction device which corrects an incorrect photography date which has been entered by the photographic device to a correct photography date.

In order to attain the aforementioned object, the present invention is directed to an image editing method comprising the steps of: inputting an image which is photographed by a predetermined photographic device; determining whether or not a date which has been entered by the photographic device is present in the image which has been inputted at the step of inputting; determining whether or not to insert a date into the image which has been inputted at the step of inputting according to a result of the step of determining a date presence; and inserting the date into the image which has been inputted at the step of inputting, if determining to insert the date into the image at the step of determining a date insertion.

In order to attain the aforementioned object, the present invention is directed to a computer readable medium having embodied thereon a computer program for processing by a compute, the computer program comprising: a first code segment for a step of inputting an image which is photographed by a predetermined photographic device; a second code segment for a step of determining whether or not a date which has been entered by the photographic device is present in the image which has been inputted at the step of inputting; a third code segment for a step of determining whether or not a date is inserted into the image which has been inputted at the step of inputting according to a result of the step of determining a date presence; and a fourth code segment for a step of inserting the date into the image which has been inputted at the step of inputting, if determining that the date is to be inserted into the image at the step of determining a date insertion.

The present invention is also directed to the medium wherein the medium is a propagated signal. The present invention is also directed to the medium wherein the propagated signal is a carrier wave.

As described above, according to the present invention, it is possible to output an image in which duplicate insertion of the date is avoided without an extra operation being required.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a schematic block diagram of a printer control device according to an embodiment of the present invention;

FIG. 2 is a diagram showing date information and model information described in a header of an image file according to the embodiment;

FIG. 3 is a diagram showing table information relating to date insertion according to the embodiment;

FIG. 4 is a plan view showing an example of a date region according to the embodiment;

FIG. 5 is a flowchart showing a schematic sequence of an image editing process according to a first embodiment of the present invention according to the embodiment;

FIG. 6 is a flowchart showing a schematic sequence of an image editing process according to a second embodiment of the present invention according to the embodiment;

FIG. 7 is a flowchart showing a schematic sequence of an image editing process according to a third embodiment of the present invention according to the embodiment; and

FIG. 8 is a plan view showing an example of a date-inserted image according to the embodiment.

### DETAILED DESCRIPTION OF THE PREFERRED EMBODIMENTS

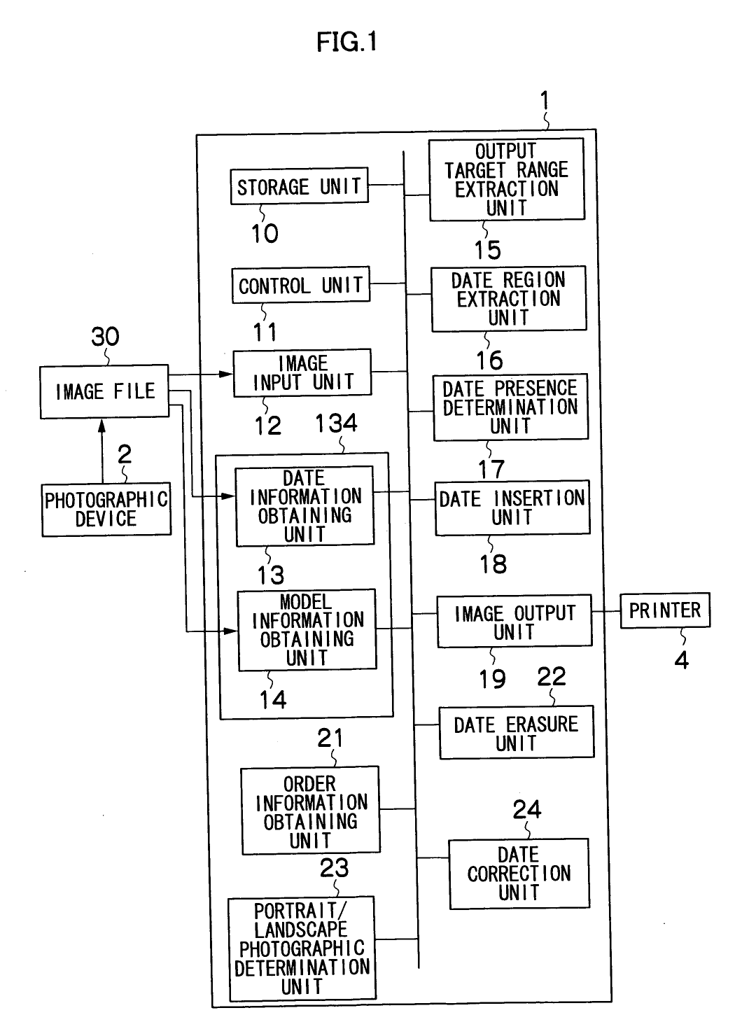

FIG. 1 is a schematic block diagram of a printer control device 1 (image editing apparatus) according to an embodiment of the present invention. As shown in FIG. 1, the printer control device 1 inserts the date into an image which has been obtained by a photographic device 2 photographing a subject, and prints the date-inserted image on a paper using a printer 4. The printer control device 1 comprises: a storage unit 10; a control unit 11; an image input unit 12; a photography information obtaining unit 134 which includes a date information obtaining unit 13 and a model information obtaining unit 14; an output target range extraction unit 15; a date region extraction unit 16; a date presence determination unit 17; a date insertion unit 18; an image output unit 19; an order information obtaining unit 21; a date erasure unit 22; a portrait/landscape photography determination unit 23; and a date correction unit 24.

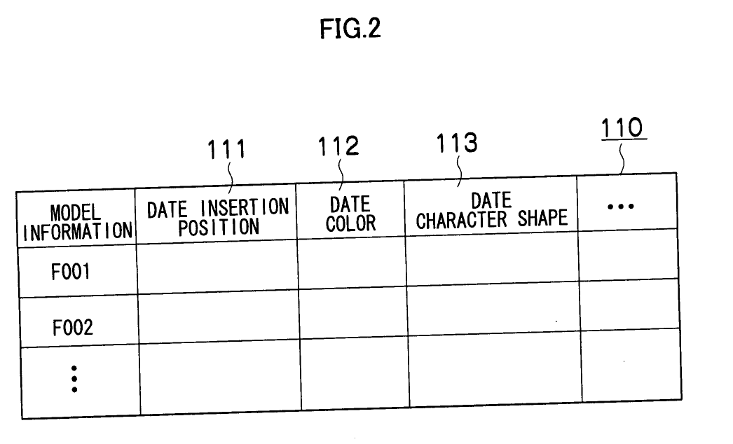

The storage unit 10 stores a date insertion table 110 shown in FIG. 2. The date insertion table 110 describes conditions (date insertion conditions) in which the date is inserted into an image when a subject is photographed with the photographic device 2, according to model of the photographic device 2. For example, the date insertion conditions include a date insertion position 111, a date color 112, and a date character shape 113, as shown in FIG. 2. The date insertion position 111 indicates the position in which the date is inserted by the photographic device 2 within an image that is obtained by photographing a subject. For example, the date insertion position 111 indicates top right, bottom right, top left, bottom left, and so on. The date color 112 indicates the color of the date. For example, the date color 112 indicates a color such as red. The date character shape 113 indicates a geometric feature and other character shape relating the date.

The image input unit 12 is a unit to which the image obtained by photographing a subject with the photographic device 2 is inputted. Though the mode relating to image input is not limited particularly, there are three modes as following, for example: a first mode in which the image is read out from a memory card or other recording medium; a second mode in which the image is received from a communications terminal such as a user's mobile telephone or a user's personal computer (hereinafter, simply “PC”) via the Internet or other network; and a third mode in which the image is obtained by being directly transmitted wirelessly or by wire from a user's mobile telephone or other photographic device.

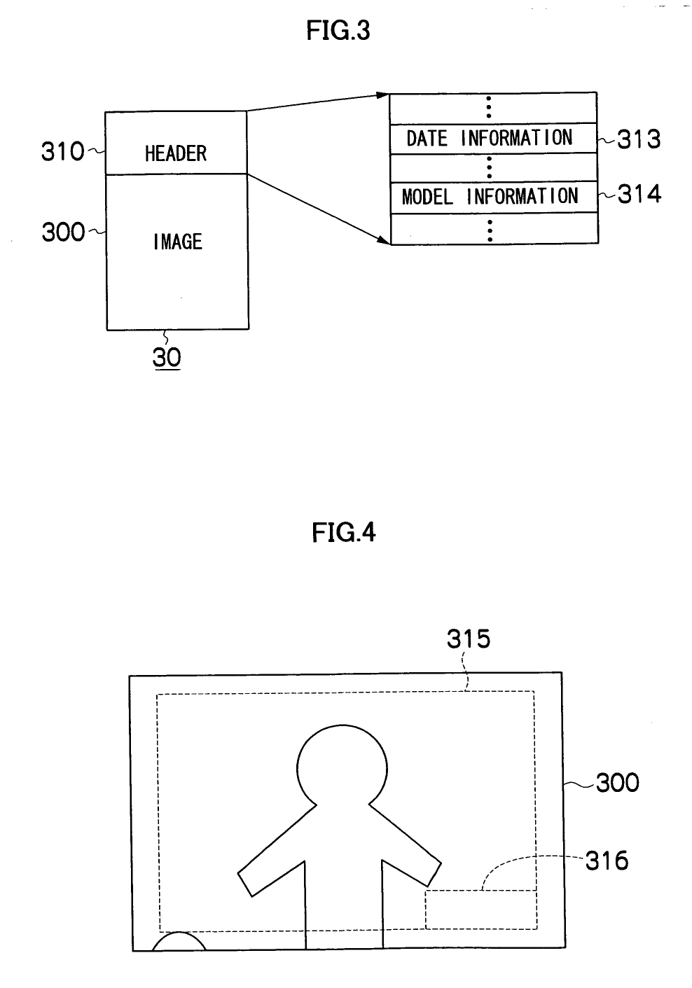

For example, as shown in FIG. 3, an image file 30 appending a header 310 to an image 300 is inputted to the image input unit 12. The image file 30 is structured in a file format of an Exif (Exchangeable image file format).

In the case of the Exif, various tag information, such as the date information 313 and the model information 314, is written in the header 310 shown in FIG. 3. More specifically, in the case of the Exif, the year/month/day and the hour/minute/second when the photographic device 2 has photographed an image, are written in the header 310 as the date information 313. Furthermore, in the case of the Exif, the manufacturer name and the model name relating to the photographic device 2 are also written in the header 310 as the model information 314. Additionally, the name of the used software may also be written. Moreover, there are also photographic devices 2 with a GPS (Global Positioning System) function of writing in the header 310 information (hereinafter referred to as “photography position information”) which indicates the position at the time of having photographed. In addition, the photographic device 2 may also write in the header 310 information (hereinafter referred to as “portrait/landscape photography information”) which indicates whether an image is photographed with a portrait orientation or with a landscape orientation.

The photography information obtaining unit 134 obtains information related to the photography at the time when the subject has been photographed with the photographic device 2 (hereinafter referred to as “photography information”). The photography information obtaining unit 134 comprises a date information obtaining unit 13 and a model information obtaining unit 14. The date information obtaining unit 13 obtains the date information 313 from the header 310 in the image file 30. The model information obtaining unit 14 obtains the model information 314 from the header 310 in the image file 30. Furthermore, when photography position information or portrait/landscape photography information are present in the header 310 of the image file 30, these sets of information are obtained from the header 310 of the image file 30 by the photography information obtaining unit 134.

Hereinafter, an example is described in a case in which the image file 30 appending the header 310 to the image 300 is inputted to the image input unit 12 as shown in FIG. 3, but the present invention is not particularly limited to those. It is possible to input a photography information file (not shown) which is a different file that is associated with the image file containing the image 300 and which includes the date information 313, the model information 314, and other photography information, together with the image file. When such the photography information file is inputted, the photography information obtaining unit 134 obtains the photography information from the photography information file. For example, the date information obtaining unit 13 and the model information obtaining unit 14 obtain the respective date information 313 and model information 314 from the photography information file.

The order information obtaining unit 21 obtains order information of a user.

There are various types of order information obtained by the order information obtaining unit 21. Firstly, there is date insertion order information that indicates whether or not there is an order for date insertion. Secondly, there is date correction order information that indicates whether or not there is an order for correcting to the correct date an incorrect date of photographing, which is inserted by the photographic device 2.

If a user requests date insertion at the time of ordering, then the date insertion order information is set to “requesting date insertion” and if a user does not request date insertion at the time of ordering, then this is set to “no need of date insertion”.

The date correction order information concerns an order that corrects the date image indicating the incorrect photographing day and hour inserted into a photographed image by the photographic device 2 to a date image indicating the correct day and hour of photographing, in following cases: a case in which the date settings in the photographic device 2 are incorrect; and a case in which a user forgets to set the date settings of the photographic device 2 from the domestic time to the time of a destination country when moving from one's own country to a foreign country for overseas travel, for example.

There are various modes for obtaining order information, such as a mode to obtain an order information file that the photographic device 2 has created, and a mode that the printer control device 1 receives an order input operation.

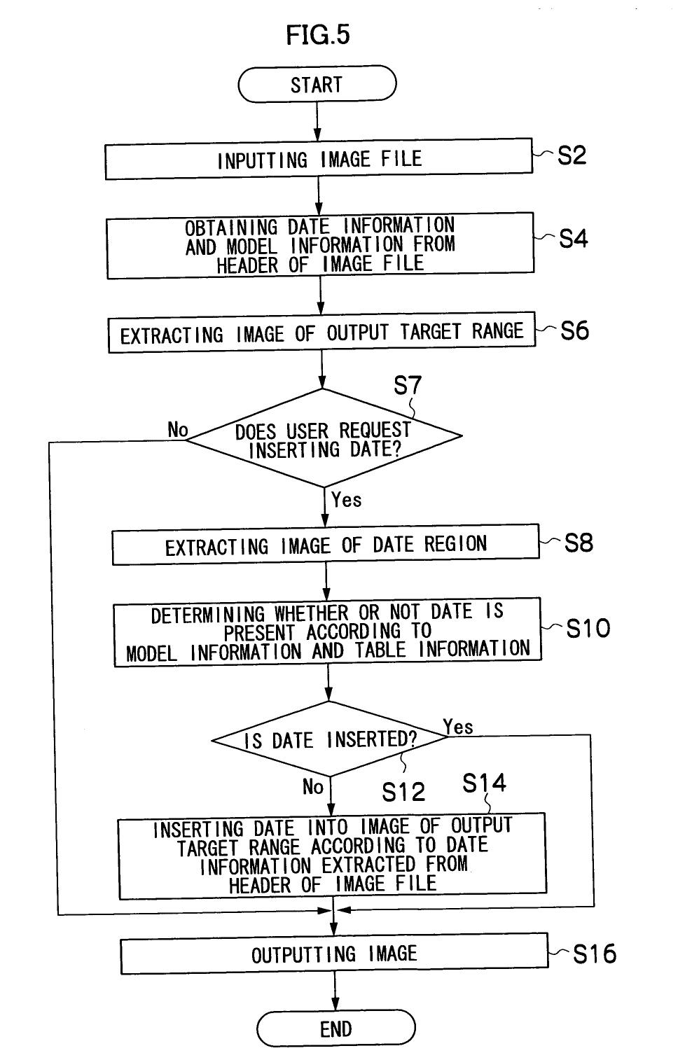

The output target range extraction unit 15 extracts an image of the output target range 315 from the image 300 (original image) of the image file 30 that has been inputted to the image input unit 12, as shown in FIG. 4. More specifically, when trimming of the image is necessary, an image of a range 315 that is to be printed on the paper is cropped out except for a portion that is cropped. On the other hand, when trimming is not necessary, the entire range of the original image 300 becomes the output target range.

The date region extraction unit 16 extracts a date region 316 from within the image of the output target range 315, according to the model information 314 obtained from the header 310 of the image file 30 and the date insertion table 110 that is stored in advance in the storage unit 10. For example, if the model information 314 extracted from the header 310 of the image file 30 indicates “F001,” the date insertion position 111 of the “F001” model is obtained from the date insertion table 110, and then the date region 316 (that is, the region in which the date is inserted when the photographic device 2 has inserted the date) is extracted according to the obtained date insertion position 111. On the other hand, if no date has been inserted by the photographic device 2, there is no date present in the date region 316. Incidentally, when the date is not present in the date region 316 due to trimming, the date is not present in the output target range 315 even if the photographic device 2 has inserted the date.

The date presence determination unit 17 determines whether or not the date is inserted within the output target range 315, according to the model information 314 obtained from the header 310 of the image file 30 and the date insertion table 110. For example, if the model information 314 extracted from the header 310 of the image file 30 is “F001,” the date presence determination unit 17 determines whether or not there is a date in the date region 316, according to the date color 112 and the date character shape 113 of the model “F001”. Incidentally, even if the specific date (what year/month/day is the date) is not identified, it is sufficient to determine whether or not a date of some kind is present.

The date insertion unit 18 inserts the date into the image of the output target range 315 according to the date information 313 obtained from the header 310 of the image file 30. For example, a date image indicating the year/month/day when the subject was photographed by the photographic device 2 is inserted. It should be noted that there is a mode in which insertion is in the order year-month-day, and a mode in which insertion is in the order day-month-year. Furthermore, the hour/minute/second may be inserted along with the year/month/day.

Such the insertion of the date image is carried out by overlaying (superimposing) the date image on a portion of the image of the output target range 315, for example. It is also possible to insert the date image by a method other than superimposing.

The date erasure unit 22 erases the date (i.e. the date image) that has already been inserted by the photographic device 2 in the image of the output target range 315, according to the model information 314 obtained from the header 310 of the image file 30 and the date insertion table 110.

The portrait/landscape photography determination unit 23 determines whether the image inputted to the image input unit 12 is a portrait orientation image or a landscape orientation image. Herein, the “portrait orientation image” refers to an image in which the subject is photographed while the photographic device 2 is in a vertical state. On the other hand, the “landscape orientation image” refers to an image in which the subject is photographed while the photographic device 2 is in a horizontal state.

There are various modes of determining the portrait/landscape photography orientations by the portrait/landscape photography determination unit 23.

Firstly, there is a mode for determining whether the image is a portrait orientation image or a landscape orientation image, according to portrait/landscape photography information which indicates whether the image obtained from the header 310 of the image file 30 is a portrait orientation image or a landscape orientation image. This mode is effective to measure the angle of the photographic device 2 by using a gyro or the like of the photographic device 2 when the subject is photographed, and to store the measured angle as the portrait/landscape photography information in the header 310 of the image file 30.

Secondly, there is a mode for determining whether the image is a portrait orientation image or a landscape orientation image, by analyzing the image that is inputted to the image input unit 12. For example, it is preferable to determine whether or not an image of a human face is contained in the image that is inputted to the image input unit 12. If a face image is contained the image inputted to the image input unit 12, the control unit 11 analyzes the orientation of the face image, and then determines whether the image is a portrait orientation image or a landscape orientation image, according to the results of the analysis.

The date correction unit 24 corrects the date image indicating the incorrect date of photography inserted into the image by the photographic device 2 to a date image that indicates the correct date of photography, in following cases: a case in which the date setting in the photographic device 2 is incorrect; and a case in which a user forgets to set the date setting of the photographic device 2 from the domestic time to the time of a destination country when moving from one's own country to a foreign country for overseas travel, for example. More specifically, the date image indicating the incorrect date of photography is erased by the date erasure unit 22, and a date image indicating the correct date of photography is inserted by the date insertion unit 18.

There are various modes of correcting the date by the date correction unit 24.

Firstly, there is a mode for correcting the date according to the photography position information and the date information (information of the day and hour of photography) obtained by the photography information obtaining unit 134. For example, if a person travels from Japan to the East Coast of the USA without changing the date setting and takes a plurality of photographic shots in the East Coast, the date correction unit 24 converts at once the date images indicating Japan time in the plurality of images obtained from that plurality of photographic shots to date images indicating the local time in the East Coast where the photographic shots have been taken. For example, the order information obtaining unit 21 obtains information indicating whether or not the image includes the incorrect date (hereinafter referred to as “correct/incorrect date information”) as a part of the date correction order information. The date correction unit 24 identifies an image to be subjected to date correction according to the correct/incorrect date information, and then determines whether or not the image is photographed in the East Coast according to the photography position information. If the date correction unit 24 determines that the image has been photographed in the East Coast, the date correction unit 24 calculates the Eastern Standard Time from the Japan time indicated in the date information. After the date erasure unit 22 erases the date image that indicates the Japan time, then the date insertion unit 18 inserts a date image that indicates the Eastern Standard Time.

Secondly, there is a mode for correcting the dates at once according the user information.

The image output unit 19 outputs the image in which the date has been inserted. Though, the image output mode is not limited particularly, for example, there are a first mode which outputs the image to the printer 4, a second mode which records the image on a recording medium such as an optical disk, and a third mode which transmits the image to a predetermined third party via the Internet or other network.

The control unit 11 comprises a CPU (central processing unit), and exercises general control over the various portions of the printer control device 1.

In the control unit 11, there are various types of control modes for date insertion. Firstly, if the date presence determination unit 17 determines that a date is inserted within the output target range 315 of the photographed image that has been inputted, the control unit 11 controls the image output unit 19 to output the image without insertion of the date by the date insertion unit 18. On the other hand, if the date presence determination unit 17 determines that a date is not inserted within the output target range 315 of the photographed image that has been inputted, the control unit 11 controls the image output unit 19 to output an image in which the date has been inserted by the date insertion unit 18. Secondly, even if the date presence determination unit 17 determines that a date is inserted within the output target range 315 of the photographed image that has been inputted, the control unit 11 determines the quality of the visibility of the date according to the difference in color between the date that is inserted and peripheral areas of the date. At this time, if the control unit 11 determines that the visibility of the inserted date is poor, the control unit 11 controls the date erasure unit 22 to erase the inserted date according to the date information 313 in the header 310 of the image file 30, and controls the date insertion unit 18 to re-insert the date within the output target range 315. Instead of erasing and re-inserting the inserted date, the date may be inserted by overwriting the inserted date. Thirdly, if there is no order for date insertion according to the date insertion order information that indicates whether or not there is an order for date insertion, the control unit 11 controls so that date insertion is not carried out by the date insertion unit 18. There is also a mode in which the above-described first to third modes are combined.

FIG. 5 is a flowchart showing a schematic sequence of an image editing process in the printer control device 1 (image editing apparatus) shown in FIG. 1 according to a first embodiment of the present invention.

First, the image file 30 including the image 300, in which a subject is photographed, is inputted (S2). Next, the date information 313 and the model information 314 are obtained 30 from the header 310 of the image file 30 (S4). Next, the image of the output target range 315 is extracted from the image 300 in the image file 30 (S6). Next, a determination is made according to the date insertion order information as to whether or not the user has requested date insertion (S7). If the user has not requested date insertion, the image of the output target range 315 is output to the printer 4 without inserting the date (S16). On the other hand, if the user has requested date insertion, then the image of date region 316 is extracted from the image of the output target range 315 according to the model information 314 and the date insertion table 110 (S8). Next, a process which determines whether or not a date is inserted within the date region 316 by the photographic device 2 is carried out according to the model information 314 and the date insertion table 110 (S10).

First, the control unit 11 determines whether or not there is a region of the date color 112 within the date region 316, for example. At this time, if there is no region of the date color 112 (for example, red color), the control unit 11 determines “no date”. On the other hand, if there is a region of the date color 112, then the date region 316 is binarized. At this time, if there is not satisfaction of conditions such as the following: (a) there are three or more regions; (b) the heights of the regions are within a predetermined range and uniform; and (c) the regions are lined up horizontally, then the date presence determination unit 17 determines “no date”. Furthermore, a thinning process on the date region 316 is carried out, and then a geometric feature quantity is calculated. For example, the directional line element feature quantity, the connectivity number, and the number of holes are used as the geometric feature quantity. When the difference between the calculated geometric feature quantity and the geometric feature quantity stored in advance (stored in advance in the date character shape 113 of the date insertion table 110) is not less than a threshold value determined in advance, the date presence determination unit 17 determines “no date”.

The process branches depending on whether or not there is a date in the date region 316 (S12). If the control unit 11 determines “no date”, the date is inserted in the image of the output target range 315 according to the date information 313 extracted from the header 310 of the image file 30 (S14), and then the image in which the date has been inserted is outputted to the printer 4 (S16). On the other hand, if the control unit 11 determines “date present,” the image of the output target range 315 is outputted to the printer 4 without date insertion being performed (S16).

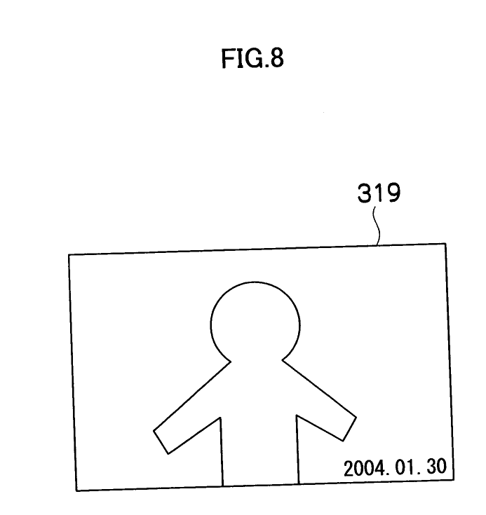

Then, as shown in FIG. 8, a date-inserted image 319 is printed on the paper by the printer 4.

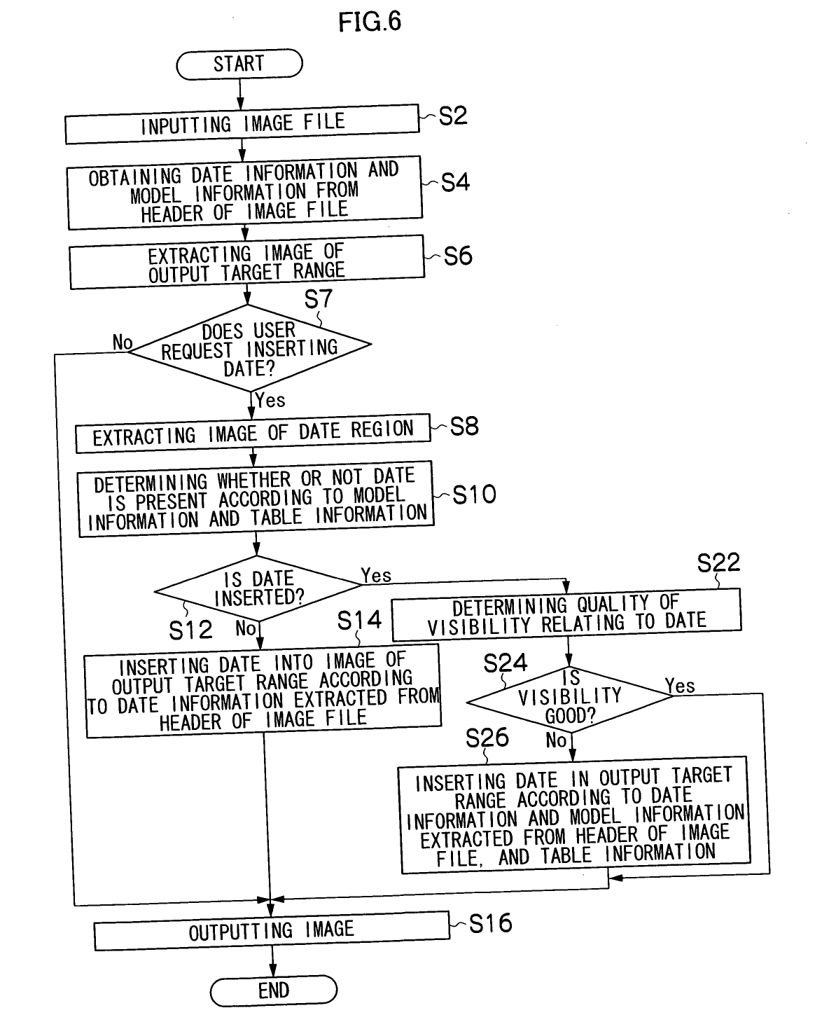

FIG. 6 is a flowchart showing a schematic sequence of an image editing process in the printer control device 1 (image editing apparatus) shown in FIG. 1 according to a second embodiment of the present invention.

As shown in FIG. 6, steps (S2 through S10), from the step of inputting the image file to the step of determining the presence of a date, are the same as the image editing process according to the first embodiment shown in FIG. 5.

In the second embodiment, in the case of determining that a date is present in the image of the output target range 315, the control unit 11 determines the quality of the visibility relating to the date image (S22). More specifically, the control unit 11 determines whether or not the date image is easily recognizable in terms of human vision, according to the difference between the color of the date image that is inserted and the color of areas peripheral to the date image. For example, the hue of the already inserted date image, and the hue of the peripheral area are compared according to a hue circle. If the angle between the hue of the peripheral area and the hue of the date image on the hue circle is not less than a predetermined angle (for example, when the date image is a red color and the peripheral area is a blue color), the control unit 11 determines that visibility of the date image is good.

If the control unit 11 determines that the visibility is poor, the date is re-inserted into the image of the output target range 315, according to the model information 314 and the date information 313 extracted from the header 310 of the image file 30, and information of the date insertion table 110. For example, the position of the inserted date is specified according to the date insertion position 111 of the specified model (for example, “F001”) which is indicated in the model information 314. Then, after the inserted date is erased, the date indicated in the date information 313 is inserted into the image of the output target range 315. The color of the date used here is a color distinct from the color of the peripheral area. For example, it is preferable to use a color that has an angle not less than a predetermined angle on the hue circle.

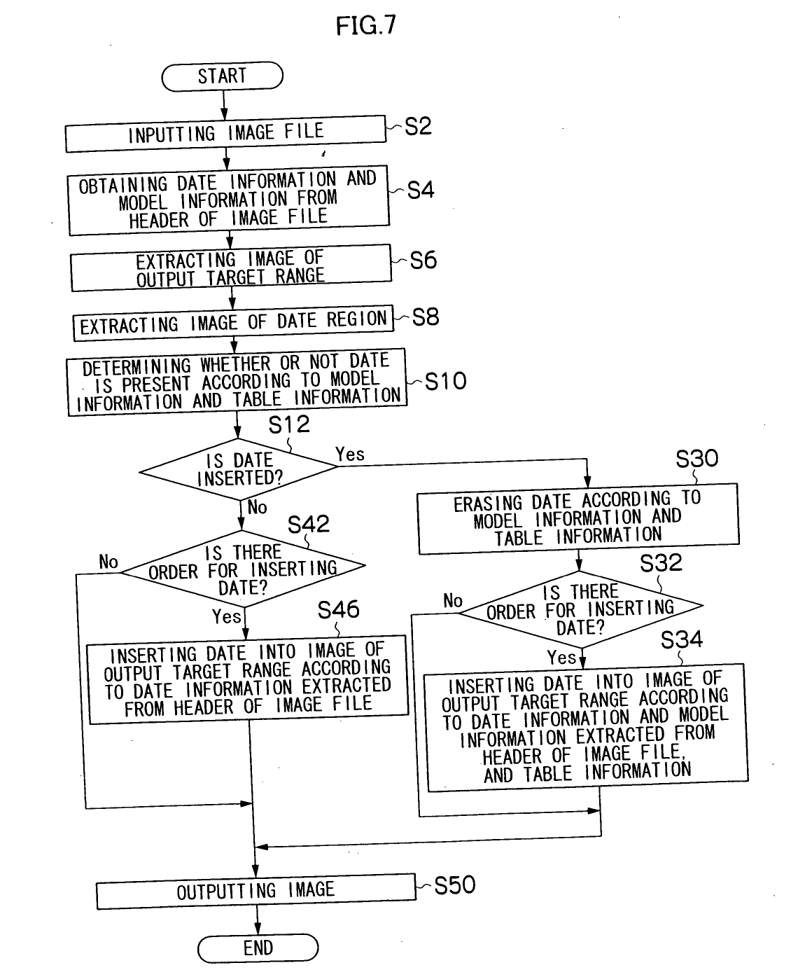

FIG. 7 is a flowchart showing a schematic sequence of an image editing process in the printer control device 1 (image editing apparatus) shown in FIG. 1 according to a third embodiment of the present invention.

First, as shown in FIG. 7, when the image file 30 containing the image 300 in which a subject is photographed is inputted (S2), the date information 313 and the model information 314 are obtained from the header 310 of that image file 30 (S4), and then the image of the output target range 315 is extracted from the image 300 within the image file 30 (S6).

Next, a date region image 316 is extracted from the image of the output target range 315 (S8), and then the date presence determination unit 17 determines whether or not a date is already inserted within the image of date region 316 according to the model information 314 and the date insertion table 110 (S10). More specifically, the date presence determination unit 17 determines whether or not a date image indicating the photography date has already been inserted by the photographic device 2 within the image of date region 316.

The process branches depending on whether or not there is a date in the image of date region 316 (S12). At this time, if the date presence determination unit 17 determines “date present,” the date erasure unit 22 erases the date from the image of the output target range 315 according to the model information 314 extracted from the header 310 of the image file 30, and information of the date insertion table 110 (S30).

There are various modes of erasing the date. Firstly, there is a mode which copies an image surrounding the date region 316 to the date region 316. Secondly, there is a mode which carries out the date erasure by interpolation according to an image surrounding the date region 316.

For example, the control unit 11 analyzes an image positioned surrounding the date region 316, and selects a mode of carrying out the date erasure by copying a partial image positioned surrounding the date region 316 to the date region 316, or a mode of carrying out the date erasure by interpolation according an image positioned surrounding the date region 316. Then, the date erasure is carried out by the selected mode, either copying or interpolation.

More specifically, the control unit 11 analyzes the texture of the image positioned surrounding the date region 316. If the images surrounding the date region 316 have the same uniform texture, the date erasure is carried out using the first mode, i.e. copying. In the case of excluding this case, in other words, if the color surrounding the date region gradually changes from the top to the bottom (or from the left to the right) of the date region, the date erasure is carried out using the second mode, i.e. interpolation.

Incidentally, the date erasure may also be carried out using a method other than the above-described copying and interpolation.

Next, after the inserted date has been erased, the control unit 11 determines whether or not there is an order for date insertion, according to the date insertion order information (S32). At this time, if there is an order for date insertion, the date is inserted into the image of the output target range 315 according to the model information 314 and the date information 313 extracted from the header 310 of the image file 30, and information of the date insertion table 110 (S46), the image into which the date is inserted is outputted to the printer 4 (S36).

When the date presence determination unit 17 determines that the date has been inserted already by the photographic device 2 according to the result of the determination step S10, the control unit 11 firstly determines whether or not there is an order for the date insertion according to the date insertion order information (S42). At this time, if there is an order for the date insertion, the date is inserted into the image of the output target range 315 according to the date information 313 extracted from the header 310 of the image file 30 (S46). Then, the image into which the date is inserted is output to the printer 4 by a printer control device 1 (S50). On the other hand, if there is no order for the date insertion, the image of the output target range 315 is output to the printer 4 without date insertion being performed (S50).

As described above, the first through third embodiments are described in a case in which inputs the image file 30 appending the header 310 to the image 300 shown in FIG. 3, but the present invention is not limited to those, particularly. It is also possible to input a photography information file including the date information 313 and the model information 314, which is a separate file that is associated with the image file including the image 300, together with the image file. When such a photography information file is inputted, the date information 313 and the model information 314 are obtained from the photography information file. At this time, if the date information 313 is a flag indicating the presence or absence of a date, that is, if a flag shows whether or not the photographic device 2 has already inserted the date, then it is possible to determine the presence or absence of a date easily by reading this flag.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image editing apparatus, comprising:
an image input device to which an image photographed by a predetermined photographic device is inputted;
a date presence determination device which determines whether or not a date which has been entered by the photographic device is present in the image having been inputted to the image input device;
a date insertion device which has a capacity of inserting a date into the image having been inputted to the image input device;
an image output device which outputs the image inputted to the image input device; and
a control device which determines whether or not to control the date insertion device to insert the date according to a result determined by the date presence determination device,
wherein if the control device determines to control the date insertion device to insert the date, the control device controls the image output device to output the image in which the date has been inserted by the date insertion device.

2. The image editing apparatus as defined in claim 1, wherein if the date presence determination device determines that the date which has been entered by the photographic device is present in the image having been inputted to the image input device, the control device controls the date insertion device to insert the date into the image having been inputted to the image input device.

3. The image editing apparatus as defined in claim 1, further comprising:
a date erasure device capable of erasing a date from the image having been inputted to the image input device,
wherein if the date presence determination device determines that the date which has been entered by the photographic device is present in the image having been inputted to the image input device, the control device controls the date erasure device to erase the date which has been entered by the photographic device from the image having been inputted to the image input device, and controls the date insertion device to insert the date into the image that the date which has been entered by the photographic device is erased by the date erasure device.

4. The image editing apparatus as defined in claim 1, wherein if the date presence determination device determines that no date which has been entered by the photographic device is present in the image having been inputted to the image input device, the control device controls the date insertion device to insert the date into the image having been inputted to the image input device.

5. The image editing apparatus as defined in claim 1, further comprising:
an order information obtaining device which obtains order information indicating whether or not there is an order for inserting the date,
wherein if there is no order for inserting the date according to the order information, the control device controls the date insertion device not to insert the date into the image having been inputted to the image input device.

6. The image editing apparatus as defined in claim 1, further comprising an order information obtaining device which obtains order information indicating whether or not there is an order for inserting the date,
wherein if there is no order for inserting the date according to the order information, the control device controls the date insertion device not to insert the date into the image having been inputted to the image input device; and controls the date erasure device to erase the date which has been entered by the photographic device.

7. The image editing apparatus as defined in claim 1, wherein if the date presence determination device determines that the date which has been entered by the photographic device is present in the image having been inputted to the image input device, the control device controls the image output device to output the image without inserting the date by the date insertion device; and
if the date presence determination device determines that no date which has been entered by the photographic device is present in the image having been inputted to the image input device, the control device controls the image output device to output the image that the date has been inserting by the date insertion device in the image having been inputted to the image input device.

8. The image editing apparatus as defined in claim 1, wherein:
if the date presence determination device determines that the date which has been entered by the photographic device is present in the image having been inputted to the image input device, the control device determines a visibility of the date according to a difference in color between the date which is entered by the photographic device and a peripheral area thereof, and
if the control device determines that the visibility of the date which has been entered by the photographic device is lower than a prescribed threshold value, the control device controls the date insertion device to insert the date into the image having been inputted to the image input device.

9. The image editing apparatus as defined in claim 1, further comprising:
a date information obtaining device which obtains at least one of date information in a header appended to the image, and date information in a photography information file associated with an image file containing the image,
wherein the date insertion device inserts the date according to the date information which is obtained by the date information obtaining device.

10. The image editing apparatus as defined in claim 1, further comprising:
a storage device which stores table information including information related to the date which has been entered by the photographic device in accordance with a model of the photographic device, and
a model information obtaining device which obtains at least one of model information in a header appended to the image, and model information in a photography information file associated with an image file containing the image,
wherein the date presence determination device determines whether or not the date which has been entered by the photographic device is present according to the model information which is obtained by the model information obtaining device, and the table information.

11. The image editing apparatus as defined in claim 10, wherein the table information includes at least one of a position, a color, and a character shape of the date which are entered by the photographic device.

12. The image editing apparatus as defined in claim 1, wherein the image output device carries out at least one of a process which outputs the image to a predetermined printer, and a process which records the image on a predetermined recording medium.

13. The image editing apparatus as defined in claim 1, further comprising:
an output target range extraction device which extracts an image of an output target range from the image having been inputted to the image input device, wherein:
the date presence determination device determines whether or not the date which has been entered by the photographic device is present in the image of the output target range; and
the date insertion device inserts the date into the image of the output target range according to a result determined by the date presence determination device.

14. The image editing apparatus as defined in claim 1, further comprising:
a portrait/landscape photography determination device which determines whether the image having been inputted to the image input device is a portrait orientation image or a landscape orientation image,
wherein the date insertion device conforms a vertical orientation of the date to be inserted in the image to the vertical orientation of the image, according to a result determined by the portrait/landscape photography determination device.

15. The image editing apparatus as defined in claim 1, further comprising a date correction device which corrects an incorrect photography date which has been entered by the photographic device to a correct photography date.

16. An image editing method, comprising the steps of:
inputting an image which is photographed by a predetermined photographic device;
determining whether or not a date which has been entered by the photographic device is present in the image which has been inputted at the step of inputting;
determining whether or not to insert a date into the image which has been inputted at the step of inputting according to a result of the step of determining a date presence; and
inserting the date into the image which has been inputted at the step of inputting, if determining to insert the date into the image at the step of determining a date insertion.

17. A computer readable medium having embodied thereon a computer program for processing by a compute, the computer program comprising:
a first code segment for a step of inputting an image which is photographed by a predetermined photographic device;
a second code segment for a step of determining whether or not a date which has been entered by the photographic device is present in the image which has been inputted at the step of inputting;
a third code segment for a step of determining whether or not a date is inserted into the image which has been inputted at the step of inputting according to a result of the step of determining a date presence; and
a fourth code segment for a step of inserting the date into the image which has been inputted at the step of inputting, if determining that the date is to be inserted into the image at the step of determining a date insertion.

18. The medium of claim 17, wherein the medium is a propagated signal.

19. The medium of claim 18, wherein the propagated signal is a carrier wave.
